(19) United States
(12) Patent Application Publication
(10) Pub. No.: US 2025/0010585 A1
(43) Pub. Date: Jan. 9, 2025

(54) A FIRE-RESISTANT GLAZING

(71) Applicant: Pilkington Group Limited, Lathom (GB)

(72) Inventors: Gerd MUNDRY, Dortmund (DE); Matthias AUTH, Essen (DE)

(21) Appl. No.: 18/709,836

(22) PCT Filed: Nov. 14, 2022
(86) PCT No.: PCT/GB2022/052888

§ 371 Date: May 14, 2024

(30) Foreign Application Priority Data
Nov. 15, 2021 (GB) 2116443.9

(51) Int. Cl. B32B 17/10; B32B 7/022

(52) U.S. Cl. CPC B32B 17/10311; B32B 7/022; B32B 17/10045; B32B 17/1055; B32B 2250/05; B32B 2250/40; B32B 2266/122; B32B 2307/3065; B32B 2307/412; B32B 2307/546; B32B 2307/732

(57) ABSTRACT

A fire-resistant glazing includes at least three transparent plies and at least two transparent fire-resistant layers wherein each fire-resistant layer is an interlayer for two plies and each outer ply has a bending stiffness between 1.5 and 15 times greater than a bending stiffness of at least one inner ply. In one aspect, each outer ply has thickness from 0.20 mm to 16.00 mm greater than the thickness of the at least one inner ply.

The present invention relates to a fire-resistant glazing having improved resistance to fire performance as compared to conventional fire-resistant glazings.

Fire-resistant glazings may comprise a laminate of at least two transparent plies and at least one transparent fire-resistant layer wherein each fire-resistant layer is disposed as an interlayer between two plies.

Typically, each of the transparent plies of the laminate comprises a float glass pane or a transparent sheet of an organic material such as a polycarbonate and each of the transparent fire-resistant layers comprises an inorganic intumescent material which swells or foams (intumesces) on exposure of the glazing to fire to form a barrier layer that is resistant to the passage of hot gases and flame as well as heat conduction and radiation.

The intumescence is often accompanied by a cooling effect and the release of water vapour from the intumescent material-both of which serve to reduce heat conduction through the glazing.

These fire-resistant glazings are sometimes provided with a safety glazing in order to give the fire-resistance glazing a high impact resistance. Typically, the safety glazing is a laminate comprising two glass panes and a transparent plastics film which bonds the panes together.

Nowadays, these fire-resistant glazings are used in a wide variety of fire protection glazing systems and in a wide variety of locations.

Fire-resistant glazings sold under the trade names Pyrostop® and Pyrodur® can be fitted in a vast number of door and wall partitions as well as in sloped or horizontal roofs and floors. They may even be used as building facades.

Fire-resistant glazings employing a toughened glass pane, such as those known as Pyrostop® T and Pyrodur® T, are widely used in ship bulkheads or in ship walls. They may even be used within ship hulls.

Whilst fire protection glazing systems including these fire-resistant glazings must and do meet the fire resistance classifications of the relevant building, rail and/or maritime authorities, there is always a need to improve protection against fire.

The present invention generally aims to address this need by providing a fire-resistant glazing having improved resistance to fire performance as compared to conventional fire-resistant glazings.

Accordingly, in a first aspect, the present invention provides a fire-resistant glazing comprising a laminate of at least three transparent plies and at least two transparent fire-resistant layers, wherein each fire-resistant layer is an interlayer for two plies and each outer ply has a bending stiffness between 1.5 and 15 times greater than a bending stiffness of at least one inner ply.

References herein to the bending stiffness of a ply are references to the bending stiffness of the single ply viz, the ply not forming part of the glazing.

The bending stiffness K may be calculated from the equation K=E.I, wherein E is the modulus of elasticity of the material of the ply and I is the area moment of inertia of the ply about the centroidal axis parallel to its width dimension.

Note that the area moment of inertia I of a ply is the second area moment obtained by summation of the squares of perpendicular distances of elemental areas from the centroidal axis.

For a ply having an edge (thickness) profile of regular geometric shape, the second area moment may be determined from standard formulae found in reference works (such as Lexikon der gesamten Technik) on architectural, engineering and manufacturing technology.

In the case of a ply having a rectangular edge profile, the second area moment of inertia I_{y} about the centroidal axis of the ply parallel to its width dimension has formula bh³/12 wherein b is the width of the ply and h is the thickness of the ply.

In some embodiments, the bending stiffness of each outer ply is from 3 to 10 times, for example, 5 or 8 times, greater than the bending stiffness of at least one inner ply.

In other embodiments, the bending stiffness of each outer ply is between 3 and 10 times, for example, 5 or 8 times, greater than the bending stiffness of each inner ply.

It will be appreciated that the relative bending stiffnesses of the plies may be obtained by appropriate selection in one or more of modulus of elasticity, edge profile shape and thickness of the plies.

Note that the elastic moduli of glasses can vary across a very wide range of values (viz., orders of magnitude) and will often depend on how the glasses are manufactured. A glass which has undergone toughening may have an elastic modulus which is quite different to that of the untoughened glass.

In one selection, the plies have the same edge profile and thickness but each outer ply has elastic modulus suitably greater than that of at least one, or each, inner ply.

Each outer ply may comprise the same glass, or one outer ply may comprise a different glass to that of the other outer ply. Furthermore, each inner ply may comprise the same glass different to that of each outer ply, or one or more inner ply may comprise a glass different to that of each outer ply and any other inner ply.

In some embodiments, each outer ply comprises a toughened float glass pane and each inner ply comprises an untoughened float glass pane.

In other embodiments, each outer ply comprises a float glass pane and each inner ply comprises a polycarbonate sheet, the float glass of each outer ply having a suitably different modulus to that of at least one, or each, inner ply.

In another selection, each ply has the same thickness and the same modulus but the edge profile of each outer ply is suitably different to the edge profile of at least one, or each inner ply.

The edge profiles may be rectilinear, triangular, circular, semi-circular, regular trapezoidal, hexagonal, circular ring, elliptical ring, rectangular box section, corner-, plus-, I-, T- or U-shaped profiles.

Note here, that it is preferable that at least one surface in the length dimension of the ply is flat but that curvilinear, sloped or indented surfaces are possible.

In still another selection, the fire-resistant glazing comprises plies of the same material and edge profile wherein the thickness of each outer ply is suitably different to that of at least one, or each, inner ply.

This selection is not only convenient given the wide availability of float glass pane, but also desirable because the bending stiffness of such a pane (having a rectilinear edge profile) is greatly increased (to the power of three) by even a small increase in the thickness of the pane.

In still another selection, the fire-resistant glazing may comprise plies having different edge profile, thickness and different material provided that the bending stiffness of each outer ply is suitably greater than the bending stiffness of the at least one inner pane.

In any selection, each outer ply may have a thickness from 0.20 mm to 10.00 mm greater than the thickness of at least one inner, or each ply.

Note therefore, that the present invention also provides a fire-resistant glazing comprising a laminate of at least three transparent plies and at least two transparent fire-resistant layers, wherein each fire-resistant layer is an interlayer for two plies and each outer ply has a thickness which is from 0.20 mm to 16.00 mm greater than the thickness of at least one inner ply.

The fire-resistant glazing may, in particular, have n plies and n−1 fire-resistant layers, wherein n is an integer between 3 and 15, for example, four, seven, eleven or thirteen.

In some embodiments, the fire-resistant glazing has four plies and three fire-resistant layers, five plies and four fire-resistant layers, six plies and five fire-resistant layers, seven plies and six fire-resistant layers, eight plies and seven fire-resistant layer or nine plies and eight fire-resistant layers.

The thickness of each outer ply may be between 0.50 mm and 5.00 mm, for example, 1.00 mm, 1.50 mm or 3.00 mm, greater than the thickness of the at least one inner ply.

Further, the thickness of each outer ply may be between 0.50 mm and 5.00 mm, for example, 1.00 mm, 1.50 mm or 3.00 mm, greater than the thickness of each inner ply.

In embodiments, each outer ply has a thickness greater than 3.00 mm, for example, 4.00 mm.

In these embodiments, each inner ply may have a thickness from 1.50 mm to 3.00 mm, for example, from 2.50 mm to 3.00 mm.

Note that it is not necessary that each ply is of uniform thickness but only that its average thickness corresponds to the given values.

In preferred embodiments, the fire-resistant glazing has an overall thickness less than 65 mm.

In some embodiments, each outer ply has the same thickness. Furthermore, each inner ply has the same thickness. Alternatively, one or more inner ply has a thickness which is less than the thickness of another inner ply.

In other embodiments, one outer ply has a thickness which is greater than the thickness of the other outer ply. Furthermore, each inner ply has the same thickness. Alternatively, one or more inner ply has a thickness which is less than the thickness of another inner ply.

In preferred embodiments, each ply comprises a float glass pane of same modulus and rectilinear edge profile. Each outer pane has a thickness greater than that of at least one, or each, inner pane.

Suitable inorganic glasses for the practice of the invention include alkali silicate glass, alkali borosilicate glass and alkali aluminosilicate glass as well ceramic glasses such as that sold by Nippon Electric Glass Company under the trade name Firelite®.

Suitable organic glasses include polycarbonates and poly(methylmethacrylates) sold under a number of trade names including Perspex®.

One or each outer ply may have an anti-reflective coating or a self-cleaning coating on its exterior surface. One or each inner ply may have a low emissivity coating on its outward facing surface and/or on its inward facing surface.

Note here that, float glass panes having an antireflective coating are sold under the trade name Optiview™ and float glass panes having a self-cleaning coating are sold under the trade names Activ™ and SaniTise™. Float glass panes having a low emissivity coating are sold under the trade name K Glass™.

The fire-resistant layer may comprise any fire-resistant material used the art. Preferably, the fire-resistant material comprises at least 20% by weight of water.

The fire-resistant material may comprise a hydrogel based on aluminium hydroxide or on polyacrylate. Preferably, however, the material comprises an intumescent material such as water glass. The water glass may, in particular, be a sodium water glass, a potassium water glass or a lithium water glass.

Suitable sodium water glasses include sodium silicate (SiO₂:Na₂O) water glasses wherein the SiO₂:Na₂O weight ratio at least 1.6:1.0 and preferably those in which that weight ratio is from 2.0:1.0 to 6.0:1.0, for example 4.0:1.0.

Other suitable sodium water glasses include those based on such sodium silicates (SiO₂:Na₂O) wherein the sodium ion is partially substituted by potassium ion and/or lithium ion.

The molar ratio of sodium ion to potassium and/or lithium ion in these water glasses may be at least 2:1, and in particular, range from 1.4:1.0 to 2.5:1.0.

In one embodiment, in which the water glass comprises a mixture of sodium silicate and potassium silicate, the molar ratio of sodium ion to potassium ion is at least 4.0:1.0.

Fire-resistant layers comprising sodium water glass may be provided on plies by (“pour and dry”) controlled evaporation of aqueous solutions comprising an alkali metal silicate and, optionally, a polyol, such as glycerol or diethylene glycol, an acrylate, a polysaccharide, such as cellulose or starch, or a collagen such as a gelatine to act as a cooling agent during the evaporation.

Suitable potassium water glasses include potassium silicate (SiO₂:K₂O) water glasses having relatively low water content (35% to 43% by weight) such as those described in WO 2008/053247 A1. These water glasses comprise organic silica sol and aqueous silica sol (being at least 30% by weight of solid material) such that the molar ratio of silicon dioxide to potassium oxide is at least 4.0:1 and preferably at least 4.5:1.

Fire-resistant layers comprising potassium water glass may be “cast-in-place” (CIP) by introducing the water glasses and a curing agent between adjacent plies and curing the solutions until they form a solid interlayer. The CIP method is described, for example, in U.S. Pat. Nos. 5,565,273 and 5,437,902 as well as in WO 2008/053247 A1.

The fire-resistant layers may have a thickness between 0.50 mm and 12.00 mm. Preferably, the thickness of each fire-resistant layer is between 1.00 mm and 6.00 mm, and most preferably, between 1.20 mm and 4.00 mm.

In some embodiments, each fire-resistant layer has the same thickness but in other embodiments, at least one fire-resistant layer has a thickness which is greater than (in particular, 1 to 4 times greater, for example, twice) the thickness of at least one other fire-resistant layer. A thicker fire-resistant layer can, for example, be obtained by arranging that the fire-resistant layers provided on two plies contact each other rather than adjacent plies.

The fire-resistant glazing may include at least one transparent plastics film between adjacent plies. Preferably, the plastics film is adjacent an outer ply or adjacent an innermost ply.

In embodiments, the plastics film comprises one or more of a polyvinyl acetal, such as polyvinyl butyral (PVB), an ethylene vinyl acetate, an ionomer based interlayer, such as SentryGlas® interlayer, a thermoplastic polyurethane, a polycarbonate or an acrylic resin such as Uvekol®.

The plastics film may have thickness between 0.1 mm and 10.0 mm, for example, 0.38 mm or 0.76 mm. Suitable foils providing for the plastics film are commercially available.

Note that such glazings may be obtained by providing a pre-fabricated composite glazing formed by lamination of two or more plies with one or more of a plastics film as outer ply or an inner ply in the methods described above.

In any case, the thickness, material and/or edge profile of the glass panes in the composite glazing will be chosen to conform with the requirement of relative bending stiffnesses of the fire-resistant glazing.

The fire-resistant glazing may, therefore, comprise at least four plies, at least two fire-resistant layers and a transparent plastics film, wherein the plastics film is also an interlayer for two plies.

The fire-resistant glazing may, in particular, have n plies, n−(1+m) fire-resistant layers and m plastics films, wherein n is an integer from 4 to 20, for example, seven, eleven or thirteen and m is an integer from 1 to 5, for example, one, two or three, provided that n−(1+m) is at least two.

In some embodiments, the fire-resistant glazing has four glass plies, two fire-resistant layers and a transparent plastics film, five glass plies, three fire-resistant layers and a transparent plastics film, six glass plies, four fire-resistant layers and a transparent plastics film or seven glass plies, five fire-resistant layers and a transparent plastics film.

In a preferred embodiment, the plastics film is adjacent an outer ply or an innermost ply.

The fire-resistant glazing according to the present invention may conform to A2-s1,d1 or higher determined according to EN 13501-2 (2016).

The fire-resistant glazings may, in particular, conform to EI 30, EI 60, EI 90, EI 120 or EI 190 measured according to EN 1634-1 (2014). They may also conform to EW 30, EW 60, EW 90, EW 120 or EW 190 measured according to 1634-1 (2014).

The fire-resistant glazings may alternatively or additionally conform to A0, A15, A30, A60, BO or B15 measured according to International Maritime Organisation standard IMO A.754 (18).

The fire-resistant glazings may also conform to A1-15, A1-30, A2-15 or A2-30 measured according to European standard (railway vehicles) EN 45545-3.

In a third aspect, the present invention provides a product for a fire protection system, comprising the fire-resistant glazing of the first or second aspect.

Embodiments in this aspect will be apparent from the first and second aspects of the present invention.

The product may be one providing for use of the glazing as a fixed glazing or within a partial or full-sized fire door, a wall, a roof, a floor a bulkhead or a vehicle.

Alternatively, the product may be a semi-finished product for use with other products providing security installations.

The fire protection system may comprise an insulated glass unit (IGU), such as a double or triple glazing. The IGU may comprise at least one fire-resistant glazing according to the first or second aspect of the present invention in combination with a conventional laminated safety glass.

Alternatively, the IGU may comprise at least one fire-resistant glazing including a plastics film and at least one fire-resistant glazing not including a plastics interlayer according to the present invention.

The IGU may, in particular, comprise a fire-resistant glazing having four plies and three fire resistant layers in combination with a fire-resistant glazing having four plies, two fire resistant layers and a plastics layer.

In a fourth aspect, the present invention provides a fire protection system, including the fire-resistant glazing of the first or second aspect.

Embodiments in this aspect will be apparent from the first and second aspects of the present invention.

The present invention will now be described in more detail with reference to the accompanying drawings in which:

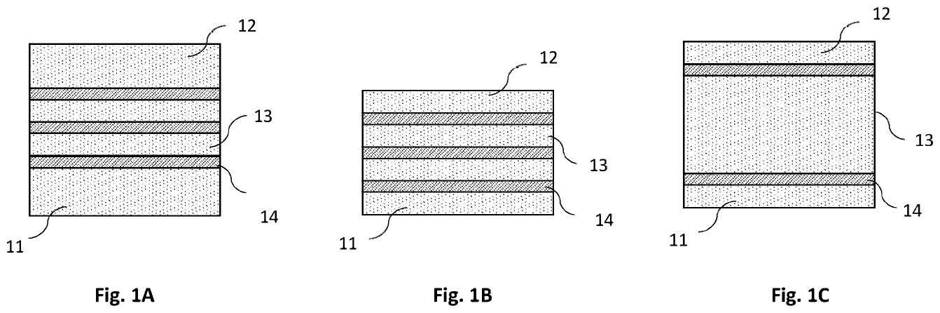

FIG. 1A shows a cross-section view of a fire-resistant glazing according to one embodiment of the present invention and FIGS. 1B and 1C show cross-section views of certain other glazings:

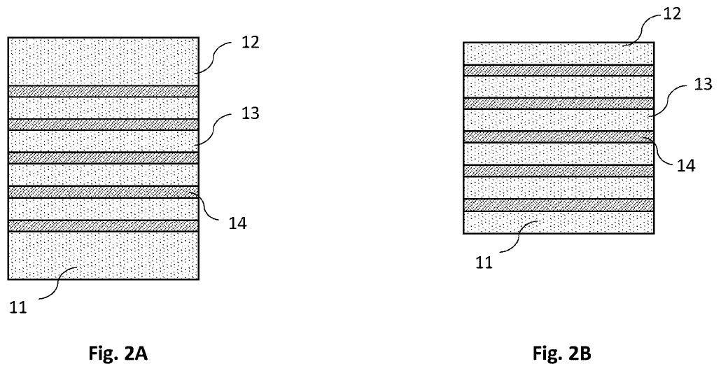

FIG. 2A shows a cross-section view of a fire-resistant glazing according to another embodiment of the present invention and FIG. 2B shows a cross-section view of a certain other glazing;

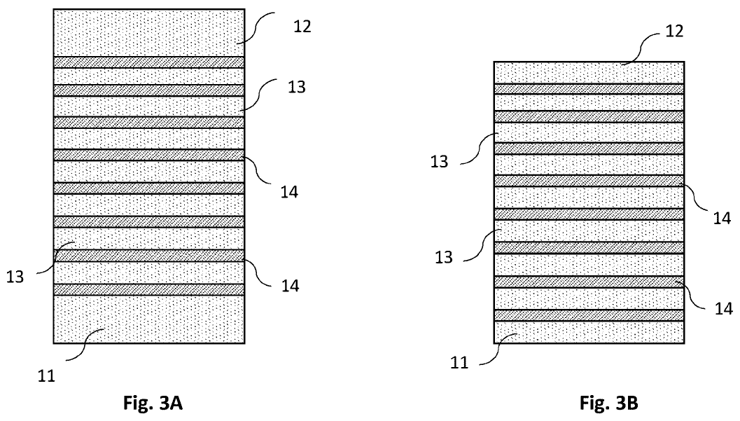

FIG. 3A shows a cross-section view of a fire-resistant glazing according to still another embodiment of the present invention and FIG. 3B shows a cross-section view of a certain other glazing;

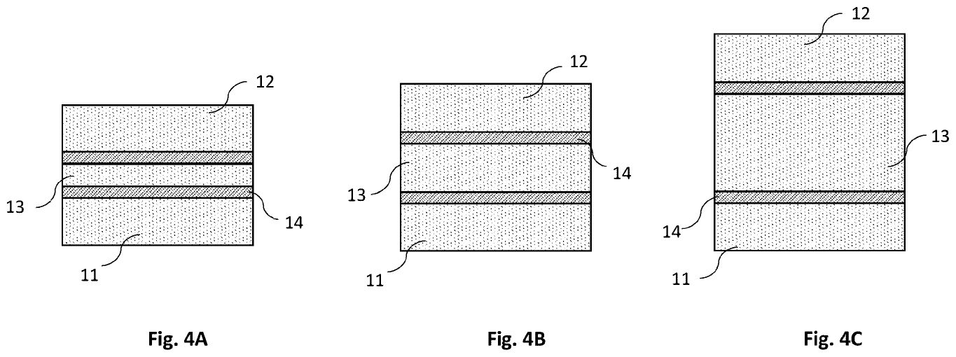

FIG. 4A shows a cross-section view of a fire-resistant glazing according to yet another embodiment of the present invention and FIGS. 4B and 4C show cross-section views of certain other glazings;

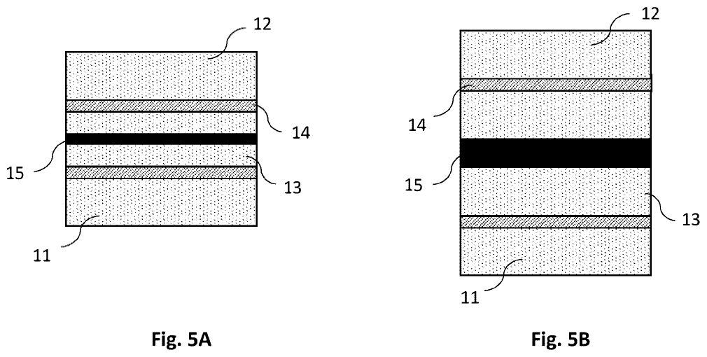

FIG. 5A shows a cross-section view of a fire-resistant glazing according to a further embodiment of the present invention and FIG. 5B shows a cross-section view of a certain other glazing; and

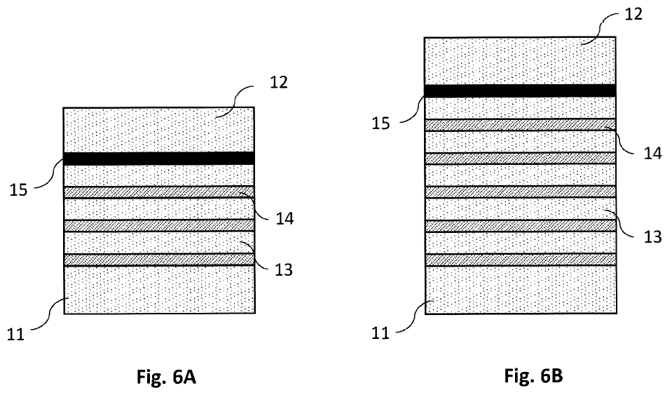

FIGS. 6A and 6B show cross-section views of fire-resistant glazings according to still further embodiments of the present invention.

The Figures compare the structures of a fire-resistant glazing according to one embodiment of the present invention with a conventional fire-resistant glazing (in which all the plies have the same thickness).

Certain of the Figures B and/or C refer to glazings having similar overall thickness to the embodiment shown but which are outside the scope of the present invention.

The fire-resistant glazings comprise a sandwich structure in which three or more rectangular glass panes (with rectilinear edge profile) of a float glass are interlayered with two or more fire-resistant layers comprising an intumescent material and, optionally, a plastics film.

Note that the panes have the same dimensions throughout but differ in thicknesses as indicated above. The fire-resistant layers comprise the same sodium silicate water glass and, except where indicated, have substantially the same thickness throughout.

FIG. 1A shows a fire-resistant glazing according to one embodiment of the present invention. The glazing has four glass panes 11, 12, 13 and three fire-resistant layers 14 (4×3; thicker outer panes).

Each cover pane 11, 12 is about 1.5 times thicker than the inner panes 13. The fire-resistant layers 14 are each about twice as thin as the inner panes 13.

FIG. 1B shows a conventional fire-resistant glazing having four glass panes 11, 12, 13 and three fire-resistant layers 14 (4×3; same pane thickness).

Each cover pane 11, 12 has the same thickness as that of the inner panes 13. The fire-resistant layers 14 are each about twice as thin as the inner panes 13.

FIG. 1C shows a fire-resistant glazing having three glass panes 11, 12, 13 and two fire-resistant layers 14 (3×2; thicker inner pane).

Each cover pane 11, 12 has the same thickness and each fire-resistant layer 14 has the same thickness. The inner pane 13 has thickness about 2.5 times greater than that of the cover panes 11, 12. The fire-resistant layers 14 are about 5 times thinner than the inner pane 13.

Table 1 below sets out the overall thickness (t) of an example of each of these glazings together with weight (wt), moment of resistance (W) and EI performance in a fire-resistance test used for DIN EN 13501 (across).

Note that the moment of resistance of the glazing is a measure of the maximum possible bending of the glazing before fracture. It was calculated (as here) by a computer aided calculation relating to the fire-resistant glazing (including the frame) of a type undertaken by structural engineers for composite structures.

In the fire safety tests, unless otherwise indicated, fire-resistant glazings having dimensions 1800 mm×3000 mm were used in UP (portrait) orientation or fire-resistant glazings having dimensions 3000 mm×1500 mm were used in an ACROSS (landscape) orientation.

In the UP orientation tests, the fire-resistant glazing was mounted within a high quality steel window frame providing edges of width 50 mm and the frame fixed within a fire test wall along three of its four sides.

In the ACROSS orientation tests, identical fire-resistant glazings were mounted within a high quality steel frame providing edges of width 50 mm. The steel frame included a cross-piece for separation of the glazings by 70 mm. The frame was fixed within a fire test wall along all four of its sides.

In each fire safety test, sensors were located centrally within quadrants of the room side pane as well as at corner of the quadrants. The eight sensors monitored the temperature and/or cracking during the fire test so as to help determine the integrity (E) and insulation (I) of the glazings.

As is well-known, the integrity E is a measure of ability of a building glazing component, such as a window or fire door, to isolate smoke gases and the insulation I is a measure of ability of the building glazing component to prevent the penetration of heat radiation.

A building glazing component may be classified in terms of these letters in combination with a time designation. For example, a building glazing having a classification E30 is able to withstand smoke penetration for 30 minutes but will not prevent the penetration of heat radiation.

A building glazing having a classification EI30 withstands smoke penetration for 30 minutes and prevents the penetration of heat radiation for 30 minutes.

The penetration of heat radiation is the point at which the mean temperature of the room side pane exceeds 140K and/or its highest temperature exceeds 180K.

Similarly, a building glazing having a classification EI45 withstands smoke penetration for 45 minutes and prevents the penetration of heat radiation for 45 minutes.

Table 1 references two fire-resistant glazings shown in FIG. 1A (A and A*) which differ from each other only in the thickness chosen for each of the fire resistance layers 14 (by about 0.1 mm).

Note that, although the glazings have similar overall thickness and are of similar weight, the mechanical stability of each of the glazings of FIG. 1A appears to be at least twice that of the glazing of FIG. 1B.

The highest EI performance belongs to the glazings of FIG. 1A in which both cover panes 11, 12 are thicker than the inner panes 13. The lowest EI performance belongs to the glazing of FIG. 1C notwithstanding that it is more mechanically stable than any of the other glazings of FIG. 1. FIG. 2A shows a fire-resistant glazing according to another embodiment of the present invention. The glazing has six glass panes 11, 12, 13 and five fire-resistant layers 14 (6×5; thicker outer panes).

TABLE 1

| Glazing | t/mm | wt/Kgm−² | W/Nmm² | EI/min Across |
|---|---|---|---|---|
| FIG. 1A | 17.1 | 40.1 | 13.6 | >>36 |
| FIG. 1A* | 17.4 | 42.0 | 13.6 | 45 |
| FIG. 1B | 14.6 | 34.4 | 5.86 | >>35 |
| FIG. 1C | 16.4 | 39.4 | 45.6 | 30 |

Each cover pane 11, 12 is about 1.5 times thicker than each of the inner panes 13. The fire-resistant layers 14 are about twice as thin as each of the inner panes 13.

FIG. 2B shows a conventional fire-resistant glazing having six glass panes 11, 12, 13 and five fire-resistant layers (6×5; same pane thickness).

Each cover pane 11, 12 has the same thickness as each of the inner panes 13. The fire-resistant layers 14 are each about twice as thin as each of the inner panes 13.

Table 2 below sets out the overall thickness (t) of an example of each of these fire-resistant glazings together with weight (wt), moment of resistance (W) and EI performance in a fire-resistance test DIN EN 13501 (across).

Note that the table references two fire-resistant glazings shown in FIG. 2A (A and A*) which differ from each other only in the thickness chosen for each of the fire resistant layers 14 (by about 0.1 mm).

TABLE 2

| Glazing | t/mm | wt/Kgm−² | W/Nmm² | EI/min Across |
|---|---|---|---|---|
| FIG. 2A | 25.4 | 55.0 | 15.37 | >66 |
| FIG. 2A* | 24.9 | 54.4 | 15.37 | ~62 |
| FIG. 2B | 22.6 | 53.0 | 8.79 | 66 |

Note further that, although the fire-resistant glazings have similar overall thickness and are of similar weight, the mechanical stability of each of the fire-resistant glazings of FIG. 2A appears to be about twice that of the fire-resistant glazing of FIG. 2B.

The highest EI performance belongs to the glazings of FIG. 2A in which both cover panes 11, 12 are thicker than the inner panes 13.

FIG. 3A shows a fire-resistant glazing according to still another embodiment of the present invention. The glazing has nine glass panes 11, 12, 13 and eight fire-resistant layers 14 (9×8; thicker outer panes).

Each cover pane 11, 12 is about 1.5 times thicker than each of the inner panes 13. The fire-resistant layers 14 are about twice as thin as each of the inner panes 13.

FIG. 3B shows a conventional fire-resistant glazing having nine glass panes 11, 12, 13 and eight fire-resistant layers 14 (9×8; same thickness).

Each cover pane 11, 12 has the same thickness as that of each of the inner panes 13. The fire-resistant layers 14 are about twice as thin as each of the inner panes 13.

Table 3 below sets out the overall thickness (t) of an example of each of these fire-resistant glazings together with weight (wt), moment of resistance (W) and EI performance in a fire-resistance test DIN EN 13501 (across).

TABLE 3

| Glazing | t/mm | wt/Kgm−² | W/Nmm² | EI/min Across |
|---|---|---|---|---|
| FIG. 3A | 37.4 | 90.7 | 20.92 | >96 |
| FIG. 3A* | 36.4 | 88.2 | 15.37 | >93 |
| FIG. 3B | 34.6 | 83.7 | 13.18 | 90 |

FIG. 3A, 2800 mm × 1700 mm

Note that the table references two fire-resistant glazings shown in FIG. 3A (A and A*) which differ from each other only in the thickness chosen for each of the fire resistant layers 14 (by about 0.1 mm).

Note that, although the fire-resistant glazings have similar overall thickness and are of similar weight, the mechanical stability of each of the fire-resistant glazings of FIG. 3A is considerably higher than that of the fire-resistant glazing of FIG. 3B.

Note further that, the highest EI performance belongs to the fire-resistant glazings of FIG. 3A in which both cover panes 11, 12 are thicker than the inner panes 13.

FIG. 4A shows a fire-resistant glazing of yet another embodiment of the present invention. The fire-resistant glazing also has three glass panes 11, 12, 13 and two fire-resistant layers 14 (3×2; thicker outer panes).

Each cover pane 11, 12 is about 1.5 times thicker than the inner pane 13. The fire-resistant layers 14 are about 1.7 times as thin as the inner pane 13.

FIG. 4B shows a conventional fire-resistant glazing similar to that shown in FIG. 1B. The glazing has three glass panes 11, 12, 13 and three fire-resistant layers 14 (3×2; same pane thickness).

Each cover pane 11, 12 has the same thickness as that of the inner pane 13. The fire-resistant layers 14 are each about 1.7 times as thin as the inner pane 13.

FIG. 4C also shows a fire-resistant glazing similar to that shown in FIG. 1C. The glazing has three glass panes 11, 12, 13 and two fire-resistant layers 14 (3×2; thicker inner pane).

Each cover pane 11, 12 has the same thickness and each fire-resistant layer 14 has the same thickness. The inner pane 13 has thickness about 2.3 times greater than that of the cover panes 11, 12. The fire-resistant layers 14 are about 3.75 times thinner than the inner pane 13.

Table 4 below sets out the EI performance of an example of each of these glazings as well as a fire-resistant glazing of FIG. 1A in fire-resistance and smoke control tests EN 1634-1 (various formats).

Note that the highest EI performance is obtained by the fire-resistant glazing of FIG. 1A in which both cover panes 11, 12 are thicker than the inner pane 13.

FIG. 5A shows a fire-resistant glazing according to a further embodiment of the present invention. The glazing has four glass panes and two layers of an alkali metal silicate and a layer of polyvinyl butyral 15 (4×3; thicker outer pane).

Each cover pane 11, 12 is about 2.6 times thicker than the inner panes 13. The fire-resistant layers 14 are each of similar thickness as the inner panes 13. The PVB layer 15 is located at the centre of the glazing and is about 4 times as thin as the inner panes 13.

TABLE 4

| | | EI/min | | |
|---|---|---|---|---|
| Glazing | t/mm | Across | Up | IGU Across |
| FIG. 4A | 13.8 | — | 30 | — |
| FIG. 4B | 15.2 | 38 | 28 | 26 |
| FIG. 4C | 17.2 | 18 | 36 | — |
| FIG. 1A* | 17.4 | 47 | 45 | 42 |

FIG. 5B shows a conventional fire-resistant glazing similar to that shown in FIG. 1B (4×3; same pane thickness). The glazing has four glass panes 11, 12, 13, two fire-resistant layers 14 and a layer of polyvinyl butyral (PVB) 15.

Each cover pane 11, 12 has the same thickness as each of the inner panes 13. The fire-resistant layers 14 are each about 2.5 times as thin as each of the inner panes 13. The PVB layer 15 is located at the centre of the glazing and has thickness about 5 times thinner than each of the inner panes 13.

Table 5 below sets out the EI performance of an example of each of these fire-resistant glazings as compared to the fire-resistant glazings of FIG. 1A and FIG. 4A in fire-resistance tests for DIN EN 13501-2 (across).

Note that when the PVB layer 15 is present, the highest EI performance belongs to the fire-resistant glazing of FIG. 5A in which both cover panes 11, 12 are thicker than the inner panes 13.

Note also that the EI performance for this fire-resistant glazing is still better than that of the fire-resistant glazing shown in FIG. 4A but is not as good as that of the fire-resistant glazing of FIG. 1A.

Note also that the PVB layer 15 acts as a sufficient barrier layer providing that the fire-resistant glazing of FIG. 5B passes the fire-resistance and smoke control test.

TABLE 5

| | | EI/min |
|---|---|---|
| Glazing | t/mm | (Up) |
| FIG. 5A | 18.0 | 28 |
| FIG. 5B | 14.2 | 33 |
| FIG. 4A | 13.8 | 30 |
| FIG. 1A* | 17.4 | 45 |

FIG. 6 shows fire-resistant glazings according to the present invention include a plastics layer adjacent an outer pane.

FIG. 6A shows a fire-resistant glazing having five glass panes, 11, 12, 13, three fire-resistant layers 14 and a PVB layer 15 (5×4).

Each cover pane 11, 12 is about 1.5 times thicker than each of the inner panes 13. Each fire-resistant layer 14 is about twice as thin as each of the inner panes 13. The PVB layer 15 is located adjacent a cover pane 12 of the glazing and is about 7 times as thin as the inner pane 13.

FIG. 6B shows a fire-resistant glazing having seven glass panes, 11, 12, 13, five fire-resistant layers 12 and a PVB layer 15 (7×6).

Each cover pane 11, 12 is about 1.5 times thicker than each of the inner panes 13. Each fire-resistant layer 14 is about twice as thin as each of the inner panes 13. The PVB layer 15 is located adjacent a cover pane 12 of the glazing and is about 7 times as thin as each of the inner panes 13.

The fire-resistant glazings of FIG. 5A and FIG. 6 may offer a fire-resistant and impact-resistant glazing. They may be used in an IGU in combination with the fire-resistant glazing of FIG. 1A. The fire-resistant glazings of FIG. 6 may be used within an IGU in combination with a fire-resistant glazing of any one of FIG. 2A, 3A or 4A.

It is clearly seen in the foregoing, that the fire-resistant glazings of the present invention offer improved resistance to fire test performance as compared to conventional fire-resistant glazings.

Without wishing to be bound by theory, the improved performance is thought to result from the release of the pressure of steam build up from the fire-resistant layers through fracture of the inner panes rather than through fracture of the room side outer pane.

This preferential release to the fire side means that the fire-resistant glazing, especially in large formats, remains mechanically stable, with little or no chipping of the room side outer pane, and with better room side cooling performance during a longer period during the fire.

The fire-resistant glazings of the present invention also offer improved mechanical stability for handling and installation whilst maintaining acceptable weights.

The likelihood of glass breakage during installation, in for example, doors, is greatly reduced because the glazings are more resistant to bending and the outer panes are more resistant to cracking as compared to conventional fire-resistant glazings.

The fire-resistant glazing of the present invention may offer improved fire-resistance at the same time as providing impact resistance.

References herein to an outer ply or to each outer ply are references to a ply or the plies which provide an exterior surface of the fire-resistant glazing.

1.-24. (canceled)

25. A fire-resistant glazing, comprising a laminate of at least three transparent plies and at least two transparent fire-resistant layers wherein each fire-resistant layer is an interlayer for two plies and each outer ply has a bending stiffness between 1.5 and 15 times greater than a bending stiffness of at least one inner ply.

26. A fire-resistant glazing according to claim 25, wherein each outer ply has a thickness from 0.20 mm to 16.00 mm greater than the thickness of at least one inner ply.

27. A glazing according to claim 26, wherein each outer ply has a thickness greater than 3.00 mm, for example, 3.50 mm or 4.00 mm.

28. A glazing according to claim 26, wherein each inner ply has a thickness from 1.50 mm to 3.00 mm, for example, from 2.50 mm to 3.00 mm.

29. A glazing according to claim 25, wherein each fire-resistant layer has thickness from 0.50 mm to 12.00 mm, for example, from 1.20 mm to 4.00 mm.

30. A glazing according to claim 25, wherein the outer plies have the same thickness.

31. A glazing according to claim 25, wherein each inner ply has the same thickness.

32. A glazing according to claim 25, wherein the fire-resistant layers have the same thickness.

33. A glazing according to claim 25, wherein at least one fire-resistant layer has a thickness different to that of any other fire-resistant layer.

34. A glazing according to claim 25, wherein at least one fire-resistant layer has a thickness which is twice the thickness of at least one other fire-resistant layer.

35. A glazing according to claim 25, wherein each ply comprises a glass pane.

36. A glazing according to claim 35, wherein the glass is a float glass.

37. A glazing according to claim 25, wherein each fire resistant layer comprises a material having a water content greater than or equal to 20%.

38. A glazing according to claim 25, wherein each fire resistant layer comprises a hydrogel.

39. A glazing according to claim 25, wherein each fire resistant layer comprises an intumescent material.

40. A glazing according to claim 25, comprising at least four plies, at least two fire-resistant layers and at least one transparent plastics film, wherein the plastics film is also an interlayer for two plies.

41. A glazing according to claim 40, wherein the at least one plastics film comprises one or more of a polyvinyl acetal, an ionomer, a polyethylene vinyl acetate, a polyurethane, a polycarbonate or an acrylic resin.

42. A glazing according to claim 40, wherein the at least one plastics film has thickness between 0.10 mm and 10.00 mm.

43. A glazing according to claim 40, wherein the at least one plastics film contacts an outer ply or an innermost ply.

44. A glazing according to claim 25, having an overall thickness less than 65.00 mm.
